(19) United States
(12) Patent Application Publication
(10) Pub. No.: US 2012/0011782 A1
(43) Pub. Date: Jan. 19, 2012

(54) FENESTRATION SYSTEM WITH SOLAR CELLS

(76) Inventors: Tore Kolås, Trondheim (NO); Ragnar Fagerberg, Trondheim (NO); Lars Johnsen, Trondheim (NO)

(21) Appl. No.: 13/146,309

(22) PCT Filed: Jan. 29, 2010
(86) PCT No.: PCT/IB2010/000163

§ 371 Date: Sep. 28, 2011

(30) Foreign Application Priority Data
Jan. 27, 2009 (NO) 20090386

(51) Int. Cl. E06B 7/28; E06B 7/00

(52) U.S. Cl. 52/173.3

(57) ABSTRACT

It is described a fenestration system comprising a window pane provided with a horizontal stripe pattern of solar cells, and window blinds provided with slats operative to concentrate direct sunlight onto said solar cells and operative to redirect diffuse daylight and/or direct sunlight for improved daylight distribution within an interior space. The fenestration system may be provided with control means for automatically adjustment of said window blinds based on a number of parameters like sun position, sky conditions, energy demands, need for daylight within the interior space and need for solar shading.

### INTRODUCTION

The present invention concerns a fenestration system, especially for electrical energy production, daylight redirection and solar shading.

### BACKGROUND

Building occupants regard windows as highly important building elements. The main attributes of window openings are to enable a visual contact with the exterior surroundings and to admit daylight into the building interiors. Windows allow the building occupant an outward view and enable the occupant to keep track of changes in weather and daylight conditions.

Windows are also associated with negative factors such as heat loss, glare and unwanted solar heat. In addition, the spatial distribution of the admitted daylight is often very uneven, reducing the interior daylight quality and the potential for electric lighting energy savings.

In recent years there has been a trend towards the use of more glass in commercial buildings. Buildings with glass facades often require advanced fenestration systems with optimized performance with respect to heat transfer, solar (heat) shading and glare protection. The technological solutions include the use of gas-filled multiple glazing units, low emissive films, solar reflective films and solar shading components.

To reduce the net energy consumption in buildings, two technologies have received special attention:

(1) Daylight redirection systems are applied to utilize natural daylight and to reduce electric lighting loads and cooling loads caused by electric lighting.
(2) Solar windows are applied to convert solar energy incident on window openings into electricity.

Today's solutions for daylight redirection systems and solar windows do not exploit the full potential for energy savings and most solutions offered to the market put significant limitations on the visual contact through the window opening. The market is in need of solutions that can provide increased energy savings while also keeping the visual contact that the window is intended to provide for the building occupant.

A vertical window opening provides a non-even spatial distribution of daylight in the interiors. The light levels are high near the window wall, but drop quickly with increasing distance from the window wall. A simple redirecting light shelf can provide a more uniform distribution of daylight and thereby enhance daylight utilization. The light shelf can reduce glare problems in the window zone, and increase the amount of useable daylight in the interior zones far away from the window wall. Studies have shown that daylight redirection systems can significantly reduce the electrical energy consumption for lighting in modern office buildings.

However, a serious shortcoming of daylight redirection systems on the market today is that these systems only provide energy savings at times when daylight is needed, i.e. when the space is occupied by people. Also, many of the daylight redirection systems in the market significantly reduce the visual contact with the exterior.

In recent years there has been an increased focus on building elements that can produce energy from solar radiation. This aim can be achieved with the use of solar cells (photovoltaic cells). The market for building integrated photovoltaics (BIPV) has thus developed rapidly. Integrating solar cells in windows (solar windows) has several advantages. For high story buildings with glass facades, the fenestration systems cover a large area of the building surface. Also, since the production of today's windows requires advanced production technology, the extra cost required to integrate solar cells in windows is relatively small.

Several companies offer fenestration systems with integrated solar cells for electrical energy production. However, today's solar window solutions have some disadvantages:
Some solar windows are completely opaque, and therefore remove the two main attractions of the window opening; the visual contact with the exterior surroundings and the supply of daylight.
A second type of solar windows is semi-transparent. This allows some daylight admittance to the interiors, but normally disrupts the visual contact with the exteriors. Also, the semi-transparent solutions do little or nothing towards improving the distribution of the daylight reaching the interiors.
A third type of solar window is based on applying non-transparent solar cells in a pattern across the window pane, normally a stripe pattern. This has the benefit that visual contact is partly maintained through the transparent parts of the fenestration system. Also, daylight is admitted through the transparent window area. For this type of solar window, typically 50%, or less, of the window area is covered with solar cells. Therefore, due to the smaller area covered with solar cells the energy production is reduced correspondingly.

Today's solutions for solar windows do not exploit the potential for energy production combined with useable daylight supply and visual contact with the exterior. To obtain adequate energy production with these solutions the solar cell area has to be relatively large and this significantly reduces visual contact and daylight supply. Also, the known solutions do not discriminate between direct sunlight and diffuse daylight. Therefore, the solutions do little to prevent discomfort glare from direct sunlight, and little or nothing to improve interior daylight distribution.

### SUMMARY OF THE INVENTION

The present invention is conceived to solve or at least alleviate some of the problems outlined above.

In a first aspect the invention provided a fenestration system comprising: a window pane provided with a horizontal stripe pattern of solar cells, and window blinds provided with slats operative to concentrate direct sunlight onto said solar cells and operative to redirect diffuse daylight and/or direct sunlight for improved daylight distribution within an interior space. As compared to prior art window blind solutions, the present invention also provides improved daylight supply.

In the following description and figures it is sometimes refereed to a coordinate system relating to the fenestration system as follows: the x-axis is parallel to the longitudinal axis of the blind slats. The y-axis is directed up towards the sky zenith and the z-axis is parallel to the normal vector of the window pane (directed towards the back wall of the interior space where the fenestration system is applied). Furthermore, the azimuth angle of the sun position is the angle between the yz-plane and a vertical plane in which both the centre of the fenestration system and the sun lies.

In an embodiment said slats may be tiltable about an axis parallel to a longitudinal axis of said blind slats for adjusting an amount of direct sunlight to be concentrated onto said solar cells and an amount utilized for said daylight distribution. Further, said slats are tiltable about an axis parallel to a longitudinal axis of said blind slats to a closed position providing solar shading of said interior space. The system may also comprise means for adjusting a vertical position of the slats in parallel with respect to said solar cell stripe pattern providing adjustment of an amount of daylight concentrated onto said solar cells and an amount utilized for said daylight distribution. The fenestration system is able to regulate how direct sunlight and/or diffuse daylight is utilized according to different circumstances and occupant needs. For example, when lighting is needed, it is much more efficient to utilize the daylight source for providing daylight to the interior space instead of converting sunlight into electricity followed by converting electricity into electric lighting.

In a further embodiment a vertical spacing between the blind slats corresponds to a vertical spacing between parallel solar cell stripes. Each slat may also be operative to concentrate direct sunlight on to a corresponding horizontal solar cell stripe. An inner end of each slat may be kept fixed in a same position during tilting of the blind slats, said inner end providing an axis of rotation for said blind slats. The inner end of each blind slat may be attached to or attached adjacent to a lower end of a corresponding solar cell stripe. It may thus be possible to concentrate direct sunlight from a large variety of solar positions relative to the fenestration system onto relatively narrow stripes of solar cells.

In a further embodiment adjustment of an amount of daylight concentrated onto said solar cells and an amount utilized for said daylight distribution is accomplished by lifting or lowering an outer end of the blind slats, wherein said lifting or lowering of the blind slats provides for a change in the curvature of the blind slats. This adjustment approach may be utilized to concentrate sunlight onto the solar cells or to redirect sunlight for improved daylight utilization. A change in curvature could be beneficial to enhance system operation for a variety of solar elevation angles ranging form very low sun to high sun conditions.

The blind slats may have a concave curvature. In another embodiment at least a part of said blind slats may have a radius of curvature that decreases towards the inner end of the blind slat, wherein said part constituting at least half of said blind slat. The decreasing radius of curvature may be provided by a number of flat or curved segments with different angular orientation. The angular distribution of the redirected sunlight may be kept relatively narrow. The described slat shape allows for redirected sunlight to enter the interiors only slightly above the corresponding solar cell stripe and with a relatively flat direction angle relative to the horizontal plane. This provides an improved daylight distribution compared to solutions with blind slats with a constant radius of curvature.

The slats may be provided with a periodical structure in a direction normal to a longitudinal direction of the blind slats. The periodical structure may have a shape of side by side semicircles, overlapping semicircles or other similar shapes. Sunlight incident with a large azimuth angle (that is in a vertical plane that forms a large angle with respect to the yz-plane) may be partly redirected towards the yz-plane and other nearby vertical planes for improved daylight distribution within the interiors.

In another embodiment the window blinds may be arranged between window panes and the solar cells may be arranged in a horizontal stripe pattern comprising a number of parallel stripes on an interior window pane. The solar cells may be semi-transparent. This enhances the viewing conditions out of the window from the interior space and also the supply of daylight.

In a further embodiment an upper side of said blind slats may be highly specular with a high reflectance value, preferably at least 80%. The highly reflective surface will enhance the ability for the fenestration system to reject direct sunlight in shading mode. The highly reflective surface will also enhance redirection and concentration of direct sunlight onto said solar cells and hence enhance the electrical energy production. In addition highly reflective surfaces will also enhance the redirection of diffuse daylight and direct sunlight into the interior space for enhanced daylight utilization. Only a minor part of the direct sunlight and also diffuse daylight will be absorbed in the blind slats itself. In some embodiments sunlight could be redirected by multiple reflections on the blind slats. In these embodiments the high reflectance will enhance reduced absorption in the slat following each reflection.

Control means may be provided for automatically adjustment of said window blinds based on a number of parameters like sun position, sky conditions, energy demands, need for daylight within the interior space and the need for solar shading.

The new fenestration system according to the invention combines the benefits of daylight redirection systems and solar windows, by combining a daylight redirection system comprising blind slats with a solar window incorporating solar cells in a stripe pattern. The vertical position and/or tilting of the blind slats can be adjusted according to user needs with respect to electrical energy production, daylight utilisation and solar shading. As compared with prior art venetian blinds, the present invention provides improved daylight supply. Compared with an unshielded window the present invention provides improved daylight distribution.

The fenestration system may have several modes of operation; electrical energy production modes, daylight utilization modes and solar shading modes. In addition, several intermediate modes may be possible; especially intermediate modes between electrical energy production and daylight utilization.

When daylight is needed in the building, the system may be configured in one of the daylight utilization modes that redirects daylight for improved daylight utilization. In these modes of operation some outward view through the fenestration system is maintained for the building occupant.

In periods with excess daylight or when occupants are not present, the system may be configured in one of the electrical energy production modes that enables concentration of incident sunlight onto the solar cells for efficient electrical energy production. Also in these modes of operation some outward view through the fenestration system is maintained for the building occupant.

When solar shading is of main object the fenestration system could be configured in solar shading mode, to prevent solar energy from overheating the interiors.

The fenestration system could be integrated in a double or a triple glazing unit. The solution could also be used in a building with double skin facade. In this case the concentrating and daylight redirecting blinds could be of much larger dimensions than what is commonly used for in-between-pane venetian blinds.

The fenestration system may typically be positioned above eye height. In this position direct sunlight redirected in a direction above the horizontal plane will not cause glare for the building occupant.

The proposed system has the potential to provide significantly higher energy savings than all systems on the market today, and also attends to the need for visual contact through the window opening.

Traditional shading solutions without solar cells include dark exterior blinds or white/grey interior blinds. Compared to such solutions, the fenestration system according to the present invention can save energy both from improved daylight utilization (reduced electric lighting loads) as well as from electrical energy production in the solar cells.

Compared to prior art fenestration systems with integrated solar cells, the fenestration system according to the present invention offers superior viewing performance. The horizontal solar cell stripes and the ability of the blind slats to concentrate sunlight onto said solar cell stripes, enables the fraction of the window area that is covered with solar cells to be kept small, typically less than ⅓, while still allowing most of the incident radiation to be utilized for energy production. In addition, the present invention offers higher energy savings due to better utilisation of daylight to illuminate the interior space.

### BRIEF DESCRIPTION OF DRAWINGS

Example embodiments of the present invention will be described with reference to the following figures, where:

FIG. 1 is an illustration of a fenestration system according to an embodiment of the invention. The system can provide electrical energy production and/or improved daylight distribution while at the same time providing reasonable viewing conditions. By tilting the blinds to a closed position the fenestration system can also provide solar shading.

FIG. 2 is an illustration (in cross-section) of a fenestration system according to a further embodiment of the invention. This configuration illustrates how the fenestration system can provide electrical energy production by concentration of sunlight onto the solar cells.

FIG. 3 is an illustration (in cross-section) of a fenestration system according to an embodiment of the invention. This configuration illustrates how the fenestration system can provide improved daylight distribution by redirecting daylight in a direction above the horizontal plane. Compared to FIG. 2, the blind slats are slightly tilted downwards (outer end).

FIG. 4 is also an illustration (in cross-section) of a fenestration system according to an embodiment of the invention. This configuration illustrates how the fenestration system can provide improved daylight distribution by redirecting daylight in a direction above the horizontal plane. Compared to FIG. 2, the blind slats are vertically lifted in parallel by a distance corresponding to the height of the solar cell stripes. Compared to the configuration in FIG. 2 the blinds may also be tilted.

FIG. 5 is an illustration (in cross-section) of a fenestration system according to an embodiment of the invention. This configuration illustrates how the fenestration system can provide solar shading by adjusting the blinds to the closed position.

FIG. 6 is an illustration (in cross-section) of a fenestration system according to an embodiment of the invention. This configuration illustrates that outward view between the solar cell stripes can be obtained by lifting the blinds to the raised position.

FIG. 7 is an illustration (in cross-section) of a fenestration system according to an embodiment of the invention. The fraction of sunlight utilized for daylighting can be controlled by a vertical adjustment of the blind slat position relative to the solar cell stripes. Left: The blind slats are lifted (compared to the configuration in FIG. 2) to allow some redirected sunlight to enter above the corresponding solar cell stripes. Right: The blind slats are lowered (compared to the configuration in FIG. 2) to allow some redirected sunlight to pass under the corresponding solar cell stripes.

FIG. 8 is an illustration (in cross-section) of a fenestration system according to an embodiment of the invention, with concave blind slats with a constant radius of curvature. The illustration also shows the blind slats organised in an open position (nearly horizontal slats) providing reasonable outward view between the blind slats and between the solar cell stripes.

FIG. 9 is an illustration of a fenestration system according to an embodiment of the invention, showing an example of a shape for the blind slat (cross-section). This shape is designed especially for a solar elevation of 45° (solar elevation as projected into the yz-plane) but can also be applied for most low sun conditions (10° to 60°) by tilting the blind slat accordingly. The outer end of the blind slat is marked with the letter A and the inner end with the letter B. The shape is comprised of 10 flat segments with different angular orientation. This shape is designed to operate together with a solar cell stripe with a height of approximately 10 units in the y-direction.

FIG. 10 is an illustration of a fenestration system according to an embodiment of the invention, showing an example of a shape for the blind slat (cross-section). This shape is designed especially for a solar elevation of 60° (solar elevation as projected into the yz-plane) but can also be applied for most high sun conditions (30° to 80°) by tilting the blind slat accordingly. The outer end of the blind slat is marked with the letter A and the inner end with the letter B. The shape is comprised of 10 flat segments with different angular orientation. This shape is designed to operate with a solar cell stripe with a height of approximately 10 units in the y-direction.

FIG. 11 is a picture of a prototype of a part of a blind slat in a fenestration system according to an embodiment of the invention, with a periodical structure along the depth of the blind slat. The periodical structure improves the distribution of redirected sunlight.

FIG. 12 is cross-section view from the front side of a part of a blind slat according to embodiments of the invention, where a periodical structure is provided along the depth of the blind slats. Left: Periodical structure in the form of side-by-side semicircles. Right: Periodical structure in the form of overlapping semi-circles.

FIG. 13 is an illustration (in cross-section) of a flexible blind slat according to an embodiment of the invention. The inner end of the slat is fixed to the corresponding solar cell or to the window pane. The shape of the slat can be adjusted by lifting or lowering the outer end of the slat. This can be utilized to concentrate sunlight onto the solar cells or to redirect sunlight for improved daylight utilization.

### DETAILED DESCRIPTION

Example embodiments of the fenestration system will now be explained with reference to the drawings. The same reference numerals indicate the same elements throughout all the drawings.

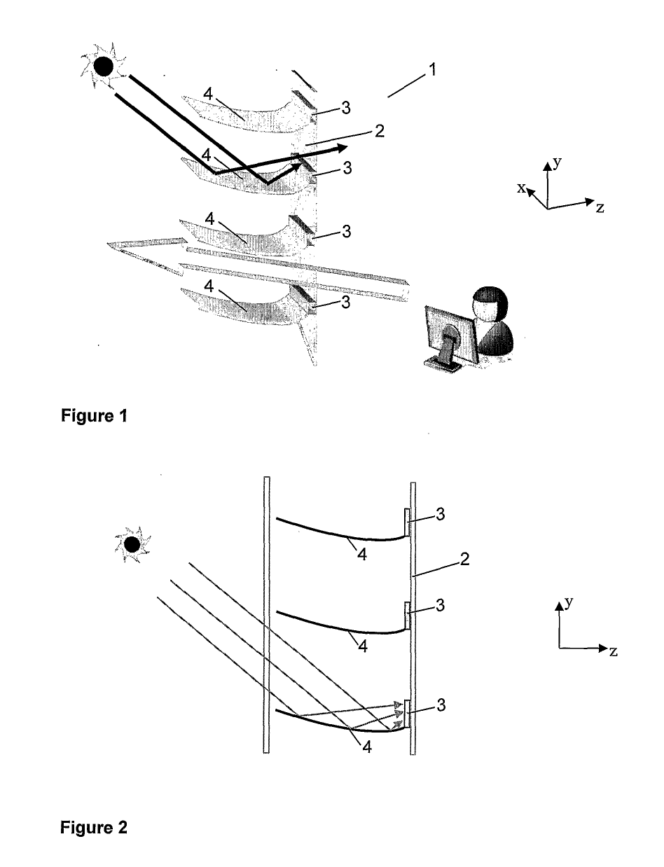

An embodiment of the new fenestration system 1 is shown in FIG. 1. The fenestration system comprises daylight redirecting blinds 4 and a stripe pattern of solar cells 3 attached to a window pane 2. As may be seen from FIG. 1, direct sunlight is concentrated onto the stripe pattern of solar cells by the redirecting blinds, but at the same time direct sunlight (and/or diffuse daylight) is redirected by the blinds through the window pane for improved daylight distribution within an interior space, e.g. inside a building. At the same time occupants inside the building will have good viewing conditions out of the window without being exposed to glare from direct sunlight or glare from redirected sunlight (provided that the fenestration system is located above eye height).

Although FIG. 1 shows an embodiment with one window pane, the redirecting blinds may be arranged between two window panes in a double glazed or triple glazed window. The solar cells may then be arranged on the inner window pane. It is possible to arrange solar cells both on the interior and exterior side of the window pane, although the exterior side, i.e. in between two window panes, is is preferred since the cells then are better protected. By window pane is meant an individual sheet of glass or other transparent material in a window opening. By window opening is meant an opening, usually covered by one or more panes of clear glass, to allow light from the outside to enter a building.

By solar cells is here meant a component that absorbs radiant energy and converts it into electrical energy. This includes energy conversion by means of photovoltaic devices.

The solar cells are provided in the form of solar cell stripes 3 attached to the window pane 2 in FIG. 1. The photovoltaic cells may be deployed on the glass during production or may be attached to the window pane after production. The stripes are preferably parallel, horizontal stripes, but other patterns are also possible.

The solar cells could be non-transparent (opaque) or semi-transparent.

A semi-transparent solution will allow parts of the redirected light to be transmitted through the solar cells. The transmitted light could be utilized for daylighting. This solution could also improve the viewing conditions.

As shown in the embodiment in FIG. 2, each blind slat 4 has assigned thereto a corresponding solar cell stripe 3. In this embodiment each blind slat is positioned so that the inner end of the blind slat is arranged under a lower end and in close proximity of the corresponding solar cell stripe. The slat may also be in contact with the actual solar cell stripe. It is also possible to fix the blind slat in this position by fixedly attaching the slat to the window pane. The blind slat may also be attached directly to the solar cell stripe itself.

The vertical spacing between the blind slats may be fixed. Each solar cell may then have assigned a particular blind slat. A fixed vertical spacing enables parallel displacement of each blind slat with respect to each assigned solar cell stripe by lifting the entire blind. Such lifting of the blind enables fine adjustment of each slat in relation to each assigned solar cell stripe. The entire slat may be lifted upwards in this movement providing exposure of only a fraction of each solar cell stripe to the direct sunlight (FIG. 7 left), or providing complete obstruction of each solar cell from direct sunlight (FIG. 4). This fine adjustment makes it possible to control the electrical energy harvesting of the solar cell, and also to create a desired balance between electrical energy production and daylight utilization.

The vertical spacing between the solar cell stripes 3 could correspond to the vertical spacing between the blind slats 4. The height of each stripe is typically less than ⅓ of the vertical spacing, implying that typically less than ⅓ of the window area is covered with solar cells. A smaller fraction, e.g. ⅙, will improve viewing conditions but also make it less practically feasible to concentrate direct sunlight (from various possible sun positions) onto the solar cells.

The width (W) of the blind slats is typically from 15 mm to 50 mm for in-between-pane applications. For exterior applications or double skin facade configurations, the width of the blinds could be much larger, typically from 50 mm to 500 mm. The spacing (S) between the blind slats is typically equal to the spacing between the solar cell stripes. This spacing distance is typically less than the blind width (W). Typical spacing to width ratios (S/W) are from 0.6 to 0.9. The height (H) of the solar cell stripes is less than the spacing between the blind slats. Typical height to spacing ratios (H/S) are from ⅙ to ⅓. This implies that the solar cell stripes will typically cover between 16% and 33% of the window area.

The blind slats may have a reflecting surface or reflecting layer. The upper side of the blinds may be nearly specular with a high reflectance value. The reflectance value is preferably at least 80%, more preferably 90% or higher. The high reflectance value makes sure that little sunlight is absorbed in the blind slats. This enhances both for efficient electrical energy production, for efficient daylight utilization as well as for effective solar shading.

The fenestration system in FIG. 2 provides a redirection of the incident sunlight in a direction towards the solar cells. This provides an efficient harvesting of the sunlight.

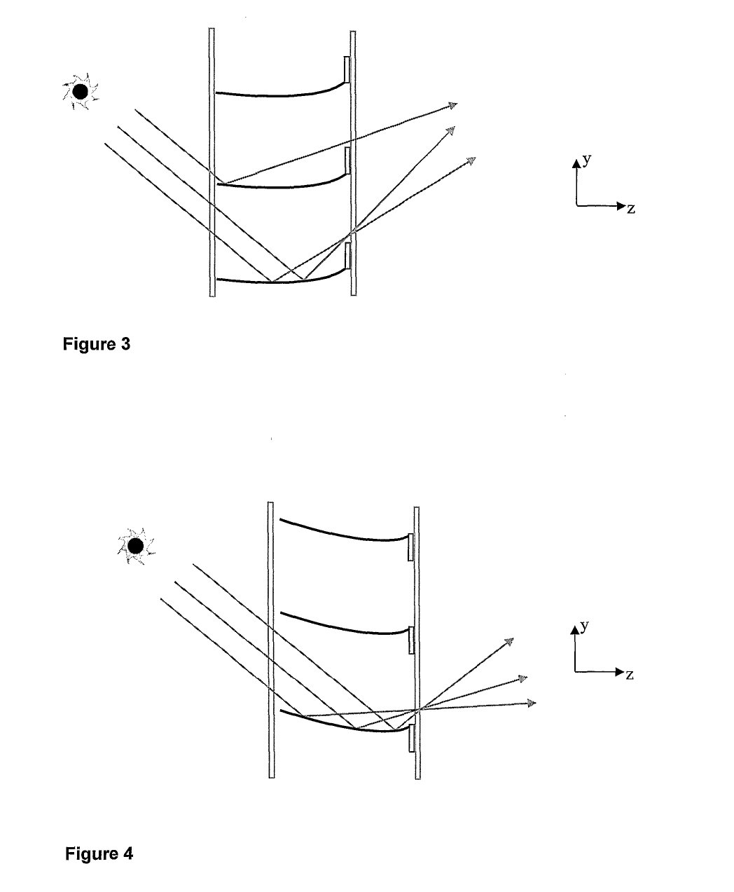

The fenestration system in FIG. 3 and FIG. 4 provides a redirection of the incident sunlight that redirects most of the light from a slat in a direction that allows the light to enter through the window pane 2 at a position located slightly above the corresponding solar cell stripe. The redirected sunlight is relatively flat in relation to the horizontal plane. By flat here means typically in the range of up to 45° above the horizontal plane (angle as projected into the yz-plane) but preferably in the range from 0° to 30° above the horizontal plane. This enables redirecting most of the sunlight towards the deeper building interiors and thereby providing efficient daylight utilization (supply and distribution).

The blind slats may be manually or automatically adjusted and/or completely raised according to needs and desires with respect to electrical energy production, daylight utilization, solar shading, viewing and glare protection.

An illustration of an embodiment of the fenestration system providing electrical energy production is shown in FIG. 2. This configuration could be applied for example when the space is not occupied or when the space is sufficiently illuminated. Here, the blind slats are positioned so that the inner end of the blind is in contact with the window close to the lower end of the corresponding solar cell stripe. The shape of the blind is designed so that most direct sunlight can be redirected towards the solar cells by tilting the blind slats according to the sun position (solar elevation and azimuth angle). During such tilting of the blind slats, the inner end of the slats is in the embodiment of FIG. 2 kept fixed in the same position. As indicated by the arrows, nearly all direct sunlight can be directed towards the solar cells 3 by the redirecting blinds 4, even if the cells cover a small fraction (less than ⅓) of the window area as shown in FIG. 2.

For this configuration it is preferable that no direct sunlight is allowed to pass (without redirection) between the inner end of the blind slat and the lower end of the corresponding solar cell stripe, as this could be causing severe glare problems for the building occupant.

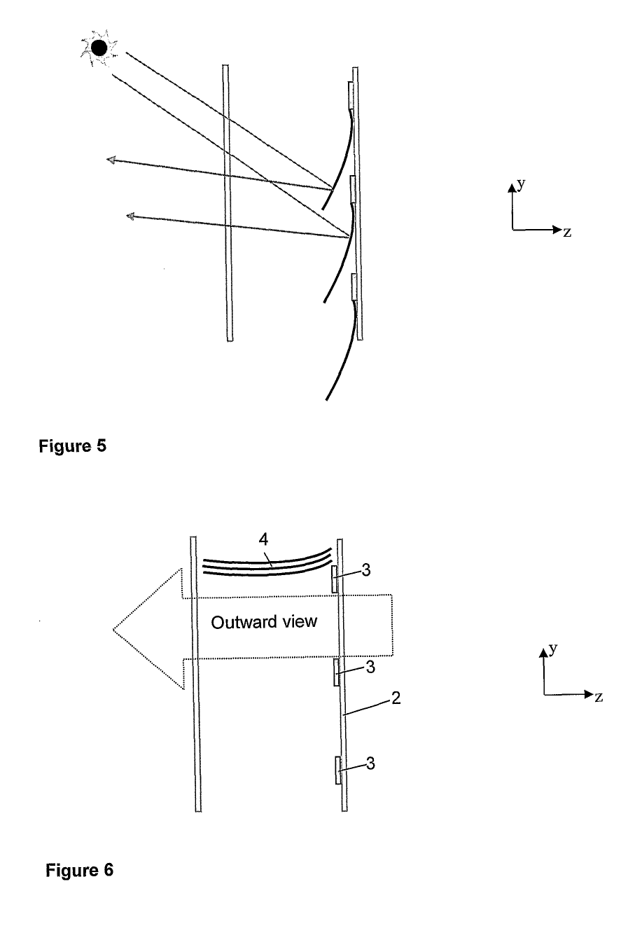

A system configuration providing solar heat shading is shown in FIG. 5. In this situation overheating is a major concern, and the blinds can be configured in the closed position (solar shading mode) indicated in FIG. 5. The blind slats are tilted downwards (outer end) to block incident visible and near infrared light from entering into the interiors of the building. At the same time the electrical energy production is also stopped, but such energy production would anyhow not provide sufficient electrical energy to remove the associated heat production. In this configuration, due to the high reflectance of the blind slats, most of the incident solar energy is reflected back to the exteriors. This provides good solar shading even when the blind slats are positioned between window panes.

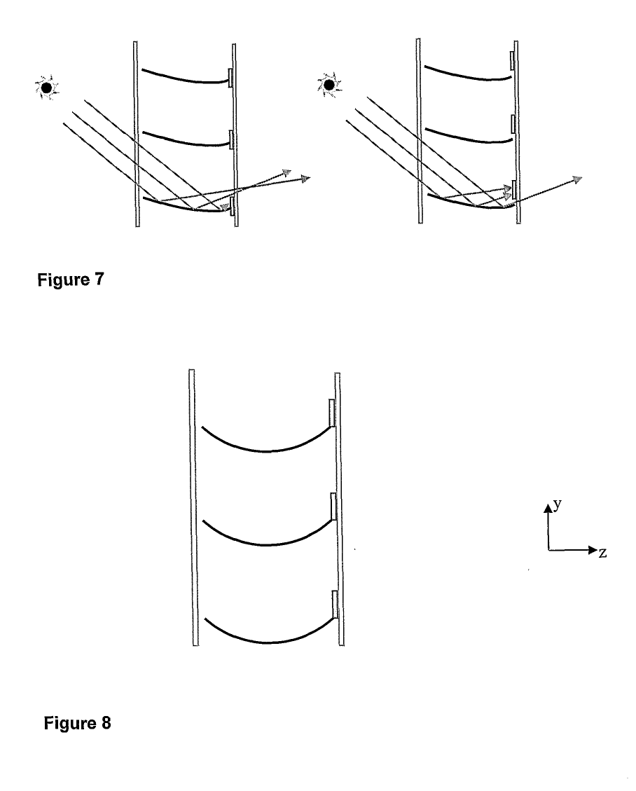

A third example is under overcast sky conditions. Under such conditions the blinds may be raised to allow unrestricted viewing between the solar cell stripes, as shown in FIG. 6. In this configuration the electrical energy production will be relatively small as the incident daylight is not concentrated onto the solar cells. Alternatively, under overcast sky conditions the blind slats may be configured in the open position to improve the daylight distribution while still partly maintaining the view through the blind slats as illustrated in FIG. 8.

A fourth example is under sunny conditions and when the interiors are not sufficiently illuminated. System configurations providing more daylight redirected to the deeper interiors of a room is shown in FIGS. 3 and 4. Here, the amount of direct sunlight that is utilized for daylighting or electrical energy production can be adjusted by tilting of the blind slats and/or vertical adjustment in parallel of the blinds (with respect to the solar cell stripes). Excess daylight can be redirected towards the solar cells for electrical energy production. FIG. 7 illustrates how light utilized for daylighting purposes can be adjusted by a vertical adjustment of the blind slats. For the operation shown in FIG. 7, it should preferably be possible to adjust the vertical position of the blind slats by a distance at least equal to the height of the solar cell stripes. This typically implies a vertical displacement of up to ⅓ of the slat spacing.

In FIG. 3, the blinds are slightly tilted downwards as compared to FIG. 2. The tilting movement is about an axis parallel to a longitudinal axis of the blind slats. In FIG. 3, the inner ends of the blind slats may be maintained in a fixed position with respect to the solar cells during the tilting movement. The inner ends of each blind slat will then provide an axis of rotation of which the tilting movement occurs.

In FIG. 7 the fraction of sunlight, utilized for daylighting purposes can be controlled by a vertical adjustment of the blind slats position relative to the corresponding solar cell stripes. As explained earlier this vertical adjustment provides a displacement in parallel of all the blind slats by the same distance, providing fine-tuning of the vertical position of each blind slat. To the left in FIG. 7, the blind slats are lifted to allow more daylight to enter above the corresponding solar cell stripes. At the same time the blind slats functions as a shade for the solar cell stripe itself, allowing only a part of the solar cell stripe to be exposed for the sunlight and thereby reducing the electrical energy production. To the right in FIG. 7, the blind slats are lowered to allow some redirected sunlight to pass under the corresponding solar cell stripes. Increased amount of redirected sunlight for daylighting will also here reduce the amount of sunlight concentrated onto the solar cells.

The configurations in FIGS. 3, 4 and 7 all have the benefit that daylight is redirected upwards relative to the horizontal plane so that glare from direct sunlight is significantly reduced provided that the fenestration system is located above eye height. In addition, the sunlight is typically redirected in a direction that is less than 45° above the horizontal plane (depending on solar elevation and azimuth). This enhances the deep penetration of the redirected light within the interior space.

The blind slats should be provided with a concave curvature, i.e. a middle part lower than the edges. The blind slats may also be provided with a reflecting surface or layer. It is possible to use blind slats with a constant radius of curvature, as shown in FIG. 8. This slat shape is known from prior art and has been applied in daylight redirecting blinds. However, this shape has the drawback that it is does not enable concentration of sunlight onto a small solar cell stripe. Also, the daylight redirected for daylighting purposes will be spread out in many directions, and only a small part of the sunlight will be redirected towards the deeper interiors (in a direction of less than 45° above the horizontal plane).

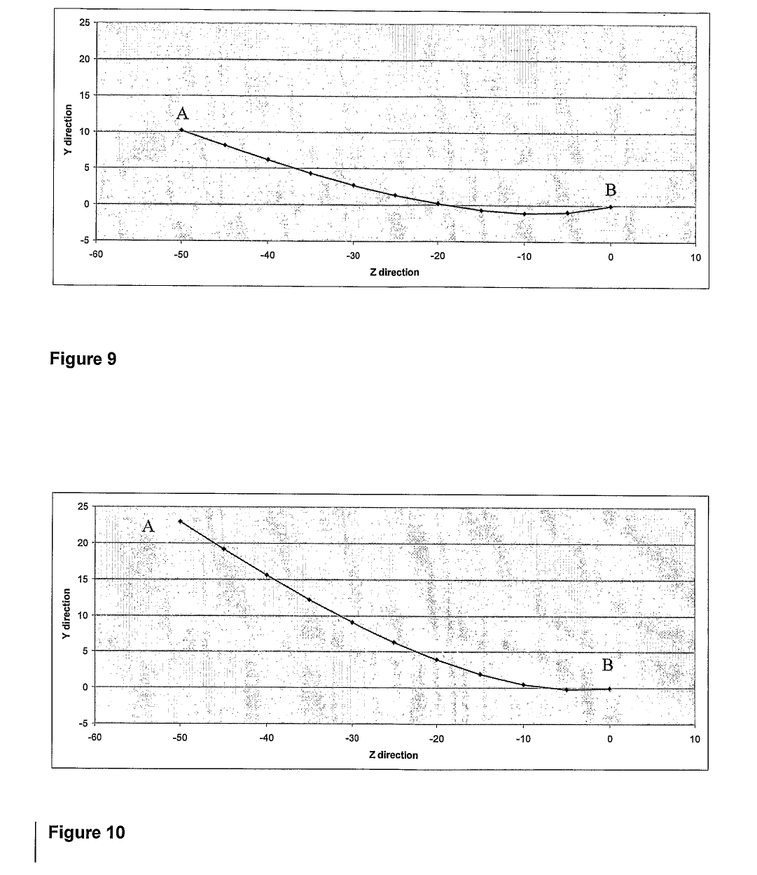

It is also possible to design the blind slats with a curvature that allows more of the sunlight to be concentrated onto narrow solar cell stripes, and/or more sunlight to be redirected (with a relatively flat angle of typically less than 45°) towards the deeper building interiors. It is proposed a new shape with a radius of curvature that decreases towards the inner end of the blind slat. Or alternatively, a similar shape can be comprised of flat sections with different angular orientation. An example of such a shape comprised of 10 flat sections is illustrated in FIG. 9. The blind slat is shown in cross-section. This shape is designed for low sun conditions (e.g. solar elevation from 10° to 60° as projected into the yz-plane). The outer end of the blind slat is marked with the letter A and the inner end with the letter B. The shape is comprised of 10 flat segments with different angular orientation. The shape shown in FIG. 9 is designed to operate together with a solar cell stripe with a height of approximately 10 units in the y-direction.

Another example of a shape comprised of flat sections is illustrated in FIG. 10. The blind slat is shown in cross-section. This shape is designed for high sun conditions (e.g. solar elevation from 30° to 80° as projected into the yz-plane). The outer end of the blind slat is marked with the letter A and the inner end with the letter B. The shape is comprised of 10 flat segments with different angular orientation. The shape shown in FIG. 10 is designed to operate together with a solar cell stripe with a height of approximately 10 units in the y-direction.

The shape in FIGS. 9 and 10 is constructed so that direct sunlight incident (at 45° and 60° respectively) on the outer end of each slat segment is reflected towards the upper end of the corresponding solar cell stripe. This gives the coordinates for the segment ends provided in Table 1:

TABLE 1
Coordinates (in arbitrary units) for the segment ends
for the slat shapes illustrated in FIG. 9 and 10.

| | |
|---|---|
| Low sun design (FIG. 9) | High sun design (FIG. 10) |

| Y | Z | Y | Z |
|---|---|---|---|
| 10.2 | −50 | 23.0 | −50 |
| 8.1 | −45 | 19.2 | −45 |
| 6.2 | −40 | 15.6 | −40 |
| 4.4 | −35 | 12.2 | −35 |
| 2.8 | −30 | 9.1 | −30 |
| 1.3 | −25 | 6.3 | −25 |
| 0.2 | −20 | 3.9 | −20 |
| −0.6 | −15 | 1.9 | −15 |
| −1.1 | −10 | 0.5 | −10 |
| −0.9 | −5 | −0.2 | −5 |
| 0.0 | 0 | 0.0 | 0 |

It is also possible to construct the shape so that the light incident at the outer parts of each slat is reflected towards the upper parts of the corresponding solar cell stripe, and light incident on the inner part of the slat is reflected towards the lower parts of the solar cell stripe, as illustrated in FIG. 2. This design will reduce the angle of incidence of light incident on the solar cell stripe, and may therefore reduce reflectance losses resulting from oblique angle light incidence on the solar cell.

It is also possible to construct a shape that directs sunlight from the outer parts of the slat towards the lower parts of the corresponding solar cell stripe. Such a shape may be less sensitive to variations in solar elevation.

The blind slat curvature illustrated in FIGS. 9 and 10 may have certain advantages over traditional (prior art) slats with constant radius of curvature:
1. The concentration of sunlight may be improved so that narrower solar cell stripes may be used.
2. By enabling narrower solar cell stripes the outward viewing potential may be enhanced.
3. More daylight may be redirected towards the deeper interiors.

In a further alternative embodiment, the blind slat may be provided with optical gratings, saw-tooth structures or other optical active structures which concentrates the direct sunlight onto the solar cell stripes on the window pane, and/or redirects direct sunlight and/or diffuse daylight into the interior space. The curvature with decreasing radius, the flat sections, the optical grating structure, the saw-tooth structure or other optical structures may be arranged on the surface of each blind slat. However, each blind slat may also be made of a transparent material, and the curvature with decreasing radius, the flat sections, the optical grating structure, the saw-tooth structure or other optical structures may then be provided inside or underneath each blind slat.

In an embodiment with blind slats attached to the solar cell stripes it is possible to allow for rotation of the blind slats by lifting or lowering the outer end of the blind slat (A) as shown in FIG. 13. This solution also allows for a change in the curvature of the blind slats that could be beneficial. The blind slats may in this way be bent to the desired shape providing conditions for electrical energy production and/or daylight utilization. Furthermore; the change in curvature obtained by lifting or lowering the out end of the blind slat could be further controlled by adjusting the mechanical properties along the width of the slat.

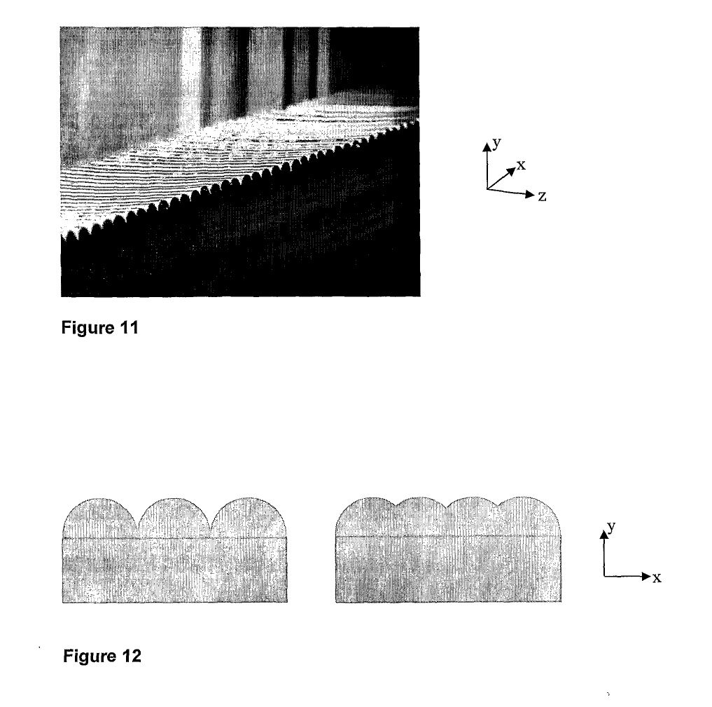

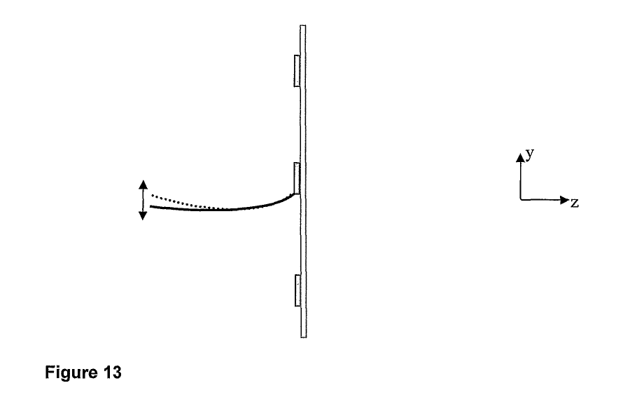

A periodical structure applied to the blind slats can improve the function with respect to daylight redirection. The periodical structure is in the embodiment shown in FIGS. 11 and 12 in the direction perpendicular to the length of the blind slat. The periodical structure may have the shape of side by side semicircles, overlapping semicircles or other similar shapes. One aim of the periodical structure is to provide a more even light distribution of redirected sunlight, irrespective of the solar azimuth angle. This will increase the amount of daylight redirected with a direction less than 45° off the z-axis, and thereby potentially be a means to increase energy savings related to lighting.

For large solar azimuth angles, it is also possible that the periodical structure may be beneficial with respect to directing light towards the solar cells in less oblique angles of incidence. This may reduce reflections at the front surface of the solar cells. The periodical structure may thereby also be a means to increase the electrical energy production.

The embodiment of the invention having a blind slat shape with constant curvature as illustrated in FIG. 8 or decreasing radius of curvature as illustrated in FIGS. 9 and 10 may further be combined with the periodic structure along the depth of the blind slats (FIGS. 11 and 12). The size of these periodic structures may be microscopic (˜1 μm) as well as macroscopic (˜1 mm).

The slat shape with a radius of curvature that decreases towards the inner end may also be applied in a daylight redirection system not comprising solar cells. The periodical structure may also be applied in a daylight redirection system not comprising solar cells.

The blind tilting and/or vertical positioning may preferably be controlled by an electric control system that takes into account the position of the sun, the sky conditions, and the need for daylight (incl. the presence or absence of people in the interior space). The control system may be provided with metering devices for measuring cloud conditions, indoor/outdoor temperature, interior space illumination etc., as well as a clock to calculate the sun position.

Having described preferred embodiments of the invention it will be apparent to those skilled in the art that other embodiments incorporating the concepts may be used. These and other examples of the invention illustrated above are intended by way of example only and the scope of the invention is to be determined from the following claims.

1-19. (canceled)

20. Fenestration system comprising:
a window pane provided with a horizontal stripe pattern of solar cells, and
a window blind provided with slats, operative to concentrate direct sunlight onto said solar cells and operative to redirect diffuse daylight and direct sunlight for improved daylight distribution within an interior space.

21. Fenestration system according to claim 20, wherein said slats are tiltable about an axis parallel to a longitudinal axis of said blind slats for adjusting an amount of direct sunlight to be concentrated onto said solar cells and an amount utilized for said daylight distribution.

22. Fenestration system according to claim 20, wherein said slats are tiltable about an axis parallel to a longitudinal axis of said blind slats to a closed position providing solar shading of said interior space.

23. Fenestration system according to claim 20, comprising means for adjusting a vertical position of the slats in parallel with respect to said solar cell stripe pattern providing adjustment of an amount of daylight concentrated onto said solar cells and an amount utilized for said daylight distribution.

24. Fenestration system according to claim 20, wherein a vertical spacing between the blind slats corresponds to a vertical spacing between parallel solar cell stripes.

25. Fenestration system according to claim 20, wherein each slat is operative to concentrate direct sunlight on to a corresponding horizontal solar cell stripe.

26. Fenestration system according to claim 20, wherein an inner end of each slat is kept fixed in a same position during tilting of the blind slats, said inner end providing an axis of rotation for said blind.

27. Fenestration system according to claim 20, wherein an inner end of each blind slat is attached to or attached adjacent to a lower end of a corresponding solar cell stripe.

28. Fenestration system according to claim 27, wherein adjustment of an amount of daylight concentrated onto said solar cells and an amount utilized for said daylight distribution is accomplished by lifting or lowering an outer end of the blind slats, wherein said lifting or lowering of the blind slats provides for a change in the curvature of the blind slats.

29. Fenestration system according to claim 20, wherein said blind slats have a concave curvature.

30. Fenestration system according to claim 20, wherein at least a part of said blind slats have a radius of curvature that decreases towards the inner end of the blind slat, wherein said part constitutes at least half of said blind slat.

31. Fenestration system according to claim 30, wherein said decreasing radius of curvature is provided by a number of flat or curved segments with different angular orientation.

32. Fenestration system according to claim 20, wherein said slats are provided with a periodical structure in a direction normal to a longitudinal direction of the blind slats.

33. Fenestration system according to claim 32, wherein the periodical structure has a shape of side by side semicircles, or overlapping semicircles.

34. Fenestration system according to claim 20, wherein said window blind is arranged between window panes, and wherein said solar cells are arranged in a horizontal stripe pattern comprising a number of parallel stripes on an interior window pane.

35. Fenestration system according to claim 20, wherein said solar cells are semi-transparent.

36. Fenestration system according to claim 20, wherein an upper side of said blind slats are specular.

37. Fenestration system according to claim 20, wherein an upper side of said blind slats have a high reflectance value, wherein said reflectance value is preferably at least 80%, and more preferably at least 90%.

38. Fenestration system according to claim 20, comprising control means for automatic adjustment of said window blind based on a number of parameters like sun position, sky conditions, energy demands, need of daylight within the interior space and need of solar shading.
